(19) United States
(12) Patent Application Publication
(10) Pub. No.: US 2012/0219056 A1
(43) Pub. Date: Aug. 30, 2012

(54) METHOD, APPARATUS, AND RECORDING MEDIUM FOR ENCODING MOTION PICTURES THROUGH SECOND PREDICTION BASED ON REFERENCE IMAGES

(75) Inventors: Sunyeon Kim, Seoul (KR); Jeongyeon Lim, Gyeonggi-do (KR); Yungho Choi, Gyeonggi-do (KR); Yoonsik Choe, Gyeonggi-do (KR); Yonggoo Kim, Seoul (KR); Younghun Jo, Seoul (KR)

(73) Assignee: SK TELECOM CO., LTD., Seoul (KR)

(21) Appl. No.: 13/394,226

(22) PCT Filed: Sep. 2, 2010
(86) PCT No.: PCT/KR2010/005978

§ 371 Date: May 14, 2012

(30) Foreign Application Priority Data
Sep. 3, 2009 (KR) 10-2009-0083174

(51) Int. Cl. H04N 7/30; H04N 7/32

(52) U.S. Cl. 375/240.03; 375/E07.214

(57) ABSTRACT

The present disclosure relates to a method, apparatus, and recording medium for encoding videos (adaptive prediction errors) through a reference image-based second prediction to reduce predictive errors and may include in an aspect: generating first prediction error signals based on input signals and prediction signals; generating second prediction error signals based on a first prediction error signal of a current block and a first prediction error signal of a reference block; performing an adaptive DCT transform followed by a quantization on the first prediction error signals or the second prediction error signals into quantized signals; and encoding the quantized signals.

### TECHNICAL FIELD

The present disclosure relates to a video data compression technology. More particularly, the present disclosure relates to a method, an apparatus, and a recording medium for encoding videos through a second prediction on the basis of the reference images which reduces predictive errors.

### BACKGROUND ART

The statements in this section merely provide background information related to the present disclosure and may not constitute the prior art.

In general, the advancement of video compression technology has set up the foundation of available methods for using visual media more effectively. In particular, the H.264/AVC video encoding technology doubled the compression performance over the earlier standard. This technology provides an encoding stage in the temporal and spatial domains based on hybrid video coding. The encoding stage in the temporal domain reduces a temporal redundancy through a motion compensated prediction from a reference frame image. The motion compensated prediction is determined by the correlation between a reference frame block and a block of an image to be currently encoded, that is the motion vector through which the block units of prediction images are obtained. Prediction errors obtained by the differences between the predicted images and the original images are arranged in units of a block, transformed in a frequency domain, quantized, and then scanned from a coefficient for representing a DC value in a zig-zag scanning. Zig-zag scanning will generate a coefficient array and the subsequent encoding stage may be optimized through CABAC or CAVLC. However, the encoding efficiency is high from the DCT transform into the frequency domain only when the prediction errors within the block has a correlation, i.e. only when they are present in a low frequency band.

[Reference 1] Matthias Narroschke, Hans Georg Musmann “Adaptive prediction error coding in spatial and frequency domain for H.264/AVC” VCEG-AB06, 16-20 Jan. 2006

In order to solve this problem, [Reference 1] suggested to provide the existing method of encoding prediction errors in frequency domain with an additional method of encoding prediction errors in spatial domain saving a DCT transform so that an adaptive determination is made whether to transform the prediction error signal for use into the frequency domain or keep the prediction error signal within the spatial domain to encode the prediction error signal.

FIG. 1 is a flowchart for illustrating a method for encoding prediction error adaptively according to a conventional technique in [Reference 1].

First, a motion compensated prediction obtains a prediction error signal of the image to be encoded at step S101.

With respect to the prediction error obtained at step S101, a DCT transform, a quantization, an inverse quantization, and an inverse DCT transform are orderly performed to obtain a cost in the frequency domain based on a distortion and a rate at step S102.

With respect to the prediction error obtained at step S101, a quantization and an inverse quantization are performed to obtain the cost in the spatial domain based on the distortion and rate at step S103.

Eventually, comparing between the costs obtained in the frequency domain at step S102 and the spatial domain at step S103, a lower cost encoding method is selected to encode the prediction error signal at step S104.

The method of FIG. 1 is premised on the assumption that skipping the DCT transform will meet an otherwise more effective event instead.

The encoding technology for the prediction error signals with the method of FIG. 1 provided a higher encoding performance over the H.264/AVC video encoding technology. However, in an even where the prediction error signals not only have low correlations in the spatial domain but also are irregularly scattered with large and small errors, that method also suffers from decreased efficiency.

### DISCLOSURE

### Technical Problem

Therefore, embodiments of the present disclosure are directed to solve the above-mentioned problems and add to the existing technology (Reference 1) for providing a method, an apparatus, and a recording medium for encoding videos through a reference image-based second prediction to reduce predictive errors.

### Technical Solution

An aspect of the present disclosure provides a method for encoding a video through a reference image-based second prediction, which may include: generating first prediction error signals based on input signals and prediction signals; generating second prediction error signals based on a first prediction error signal of a current block and a first prediction error signal of a reference block; performing an adaptive DCT transform followed by a quantization on the first prediction error signals or the second prediction error signals into quantized signals; and encoding the quantized signals, and the method may also include adaptively selecting between the quantized first prediction error signal and the quantized second prediction error signal; and encoding the adaptively selected signal.

Another aspect of the present disclosure provides an apparatus for encoding a video through a reference image-based second prediction, which may include: a first prediction signal generator for generating first prediction error signals based on input signals and prediction signals; a second prediction signal generator for generating second prediction error signals based on a first prediction error signal of a current block and a first prediction error signal of a reference block; an adaptive DCT transformer-quantizer for performing an adaptive DCT transform followed by a quantization on the first prediction error signals or the second prediction error signals into quantized signals; and an encoder for encoding quantized signals, and the apparatus may also include: an adaptive selector for adaptively select one of the quantized first prediction error signal and the quantized second prediction error signal based on a cost; and the apparatus may further include: an inverse quantizer-adaptive DCT transformer for inversely performing a quantization and an adaptive DCT transform on an output signal of the adaptive DCT transformer-quantizer; a prediction signal generator for generating the prediction signals based on an output signal of the inverse quantizer-adaptive DCT transformer; and a reference block generator for generating the reference block based on the output signal of the inverse quantizer-adaptive DCT transformer.

Yet another aspect of the present disclosure provides a computer readable recording medium for recording a program for encoding a video through a reference image-based second prediction, which may include functions of: generating first prediction error signals based on input signals and prediction signals; generating second prediction error signals based on a first prediction error signal of a current block and a first prediction error signal of a reference block; performing an adaptive DCT transform followed by a quantization on the first prediction error signals or the second prediction error signals into quantized signals; and encoding quantized signals, and the computer readable recording medium may also include a function of adaptively selecting between the quantized first prediction error signal and the quantized second prediction error signal.

In the method, apparatus, and recording medium for encoding videos through a reference image-based second prediction according to the various aspects of the present disclosure, the reference block may be unlimited to but an adjacent block of the current block in an example or a previous frame block corresponding to the current block. In addition, the reference block and the prediction signals may be based on signals generated from performing an inverse quantization and an adaptive inverse DCT transform on the quantized signals. Further, the adaptive DCT transform may selectively perform the DCT transform and the second prediction or not based on costs of the first prediction error signals calculated in a frequency domain and in a spatial domain and costs of the second prediction error signals calculated in a frequency domain and in a spatial domain after performing calculations respectively based on a distortion and a rate, with respect to first signals generated by performing a DCT transform and a quantization on the first prediction error signals or the second prediction error signals into quantized signals followed by inversely performing a quantization and a DCT transform on the quantized signals and with respect to second signals generated by performing not a DCT transform but a quantization followed by inversely quantizing the first prediction error signals or the second prediction error signals.

Yet another aspect of the present disclosure may include performing an adaptive DCT transform-quantization for determining whether to perform an encoding of prediction error signals after transforming the prediction error signals is into a frequency domain or perform the encoding in a spatial domain, or whether to have an additional second prediction firstly applied to the prediction error signals through a prediction error of an adjacent block or of a motion vector-based previous frame block and then perform the encoding of the prediction error signals after transforming the prediction error signals into the frequency domain or perform the encoding in the spatial domain.

Yet another aspect of the present disclosure may include a memory for storing a prediction error of an adjacent block or a motion vector-based previous frame block for the second prediction; a DCT transformer for transforming a prediction error sample generated by performing a second prediction through prediction errors of an adjacent block or a motion vector-based previous frame block, into a frequency domain; a quantizer in a frequency domain; a quantizer in a spatial domain; a quantizer-inverse-transformer in a frequency domain; a quantizer-inverse-transformer in a spatial domain; an inverse DCT transformer; and an adaptive control unit for determining whether to perform the second prediction based on the prediction errors of the adjacent block or the motion vector-based previous frame block and thereby switching between the respective frequency domains and the spatial domains.

Yet another aspect of the present disclosure may include determining whether to perform the encoding with the prediction error signals maintained or to firstly perform the second prediction on the prediction error based on the prediction error of the adjacent block or of the motion vector-based previous frame block and then perform the encoding operation. Yet another aspect of the present disclosure may include determining whether to perform the encoding with the prediction error signals maintained or to firstly perform the second prediction through the prediction error of the adjacent block or of the motion vector-based previous frame block and then perform the encoding operation. The second prediction through the prediction error of the adjacent block or the prediction error of the motion vector-based previous frame block is based on such a characteristic that larger prediction error signals leave more information on an image.

Yet another aspect of the present disclosure provides a reference block generator having a memory for storing the prediction error of the adjacent block or the prediction error of the motion vector-based previous frame block for carrying out the additional second prediction with respect to such prediction error signals. If there is a high correlation of the prediction error of the adjacent block and the prediction error of the motion vector-based previous frame block with a prediction error to be currently encoded, the encoding technology according to the present disclosure will provide an advantageous reduction of data rate from the conventional encoding technologies. Therefore, in terms of the prediction error signals, an embodiment of the present disclosure may perform the additional second prediction through the prediction error of the adjacent block or the prediction error of the motion vector-based previous frame block.

In yet another aspect of the present disclosure, the step of determining includes calculating a cost by using a distortion and a rate which are weighted by Lagrange parameter. Here, for the purpose of the cost, the calculation of the signals generated from the second prediction based on the prediction error of the adjacent block and the prediction error of the motion vector-based previous frame block as well as a calculation of the motion compensated prediction error as in the conventional technology are carried out. It may be determined whether to use the second prediction after completing all the calculations so that the cost is low.

Yet another aspect of the present disclosure includes reducing the temporal redundancy due to the block-based motion compensated prediction, with the prediction error signal sample provided in a prediction error block in the spatial domain or provided after the second prediction through the prediction error of the adjacent block and the prediction error of the motion vector-based previous frame block.

According to an aspect of the present disclosure, a particular code such as CABAC or the like with respect to the coding mechanism may be based on the probabilities which are separately determined with respect to coefficients in the frequency domain or samples in the spatial domain.

Yet another aspect of the present disclosure provides a method for encoding prediction error signals including performing quantization of prediction error samples in the spatial domain. In other words, according to the aspect of the present disclosure, upon completing a second prediction through a reference block prediction error of a reference block, i.e. a prediction error of the adjacent block or a prediction error of the motion vector-based previous frame block, an encoding operation in the spatial domain will be enabled as well as the encoding in the frequency domain.

According to yet another aspect of the present disclosure, performing a first prediction and/or second prediction with respect to inputted data may generate prediction error signals, and the final encoding can be carried out in a lowest cost route, i.e. the route with the smallest prediction error.

### Advantageous Effects

According to the various aspects of the present disclosure as described above, performing a reference image-based second prediction and an adaptive DCT transform (that is, adaptive quantization in the spatial domain or frequency domain) can advantageously reduce the predictive errors substantially.

### DESCRIPTION OF DRAWINGS

FIG. 1 is a flowchart for illustrating a method for encoding prediction error adaptively according to a conventional technique,

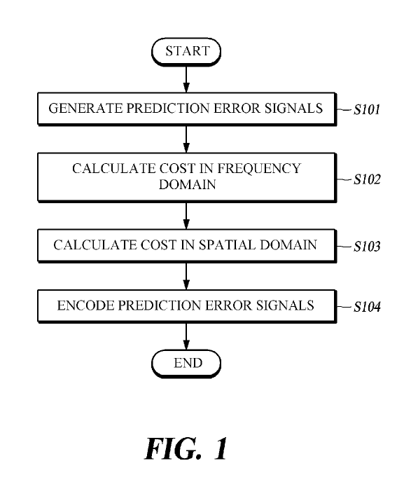

FIG. 2 is a block diagram for illustrating a video encoding apparatus through a reference image-based second prediction according to an aspect of the present disclosure,

FIG. 3 is a flowchart for illustrating a method for encoding a video through a reference image-based second prediction according to an aspect of the present disclosure, and

FIG. 4 is a block diagram for illustrating the detail of the video encoding apparatus of FIG. 2.

### MODE FOR INVENTION

Hereinafter, aspects of the present disclosure will be described in detail with reference to the accompanying drawings. In the following description, the same elements will be designated by the same reference numerals although they are shown in different drawings. Further, in the following description of the present disclosure, a detailed description of known functions and configurations incorporated herein will be omitted when it may make the subject matter of the present disclosure rather unclear.

Additionally, in describing the components of the present disclosure, there may be terms used like first, second, A, B, (a), and (b). These are solely for the purpose of differentiating one component from the other but not to imply or suggest the substances, order or sequence of the components. If a component were described as ‘connected’, ‘coupled’, or ‘linked’ to another component, they may mean the components are not only directly ‘connected’, ‘coupled’, or ‘linked’ but also are indirectly ‘connected’, ‘coupled’, or ‘linked’ via a third component.

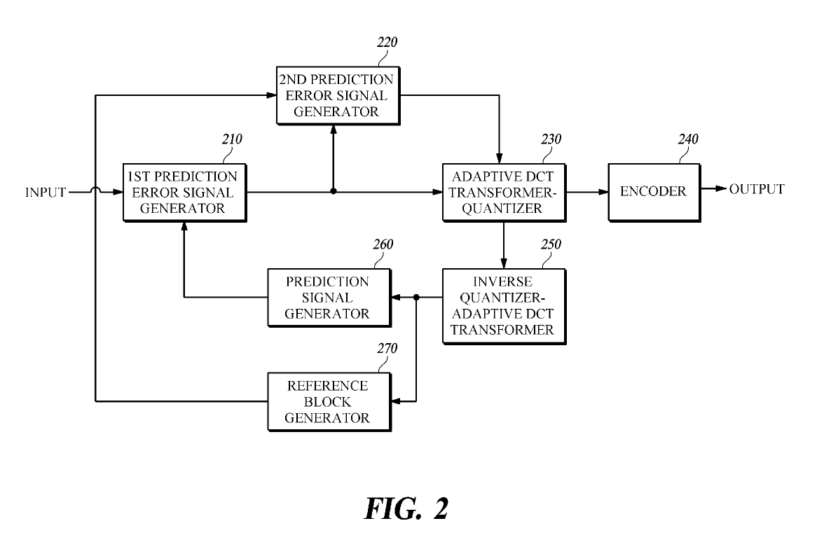

FIG. 2 is a block diagram for illustrating a video encoding apparatus through a reference image-based second prediction according to an aspect of the present disclosure which includes a first prediction error signal generator 210, a second prediction error signal generator 220, an adaptive DCT transformer-quantizer 230, an encoder 240, an inverse quantizer-adaptive DCT transformer 250, a prediction signal generator 260, and a reference block generator 270.

First prediction error signal generator 210 generates a first prediction error signal based on an input signal and a prediction signal outputted from prediction signal generator 260.

Second prediction error signal generator 220 generates a second prediction error signal based on the first prediction error signal of the current block outputted from the first prediction error signal generator 210 and the first prediction error signal of the reference block outputted from the reference block generator 270.

Adaptive DCT transformer-quantizer 230 may include an adaptive transformer (not shown) for adaptively DCT transforming the first prediction error signal from first prediction error signal generator 210 and/or the second prediction error signal from second prediction error signal generator 210 and a quantizer (not shown) for quantizing the output signal from the adaptive transformer in a frequency domain and a spatial domain. For example, the adaptive transformer of adaptive DCT transformer-quantizer 230 is adapted to selectively perform the DCT transform or not, based on costs in a frequency domain and in a spatial domain obtained based on a distortion and a rate with respect to first signals generated by performing a DCT transform and a quantization on the first prediction error signals or the second prediction error signals into quantized signals followed by inversely performing a quantization and a DCT transform on the quantized signals and with respect to second signals generated by performing not a DCT transform but a quantization followed by inversely quantizing the first prediction error signals or the second prediction error signals.

Encoder 240 encodes the signal outputted from the adaptive DCT transformer-quantizer 230.

Inverse quantizer-adaptive DCT transformer 250 may include an inverse quantizer (not shown) for inversely quantizing the output signal from the adaptive DCT transformer-quantizer 230 and an adaptive inverse DCT transformer (not shown) for adaptively and inversely DCT transforming the output signal from the inverse quantizer. For example, the adaptive inverse DCT transformer of the inverse quantizer-adaptive DCT transformer 250 is adapted to selectively perform the inverse DCT transform or not, in response to an operation of the adaptive DCT transformer of the adaptive DCT transformer-quantizer 230.

Prediction signal generator 260 generates a prediction signal based on the output signal from the inverse quantizer-adaptive DCT transformer 250. The prediction signal generator 260 may include at least a motion compensation predictor (not shown) for reducing the time domain redundancy.

Reference block generator 270 generates the reference block based on the output signal from the inverse quantizer-adaptive DCT transformer 250. The reference block may be unlimited to but an adjacent block of the current block in an example or a previous frame block corresponding to the current block in another example.

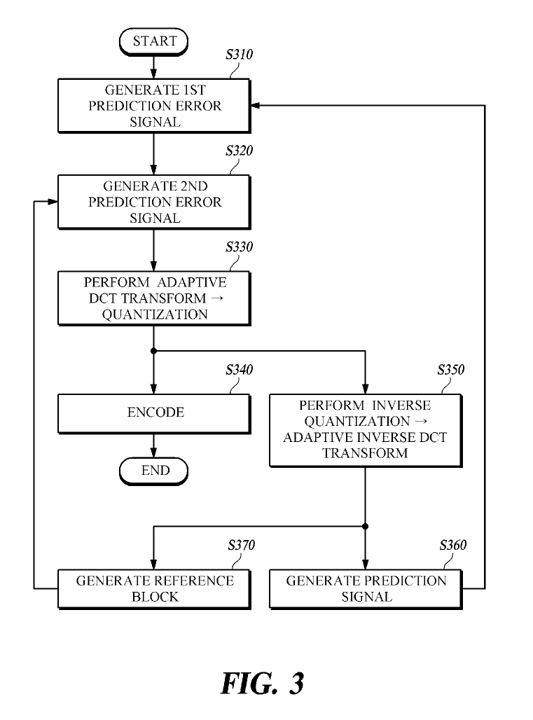

FIG. 3 is a flowchart for illustrating a method for encoding a video through a reference image-based second prediction according to an aspect of the present disclosure, which will be described as applied to the apparatus in FIG. 2.

At the start, first prediction error signal are generated in first prediction error signal generator 210 based on an input signal and a prediction signal at step S310, and a second prediction error signal is generated in second prediction error signal generator 220 based on the first prediction error signal of a current block and the first prediction error signal of a reference block at step S320.

Next, the first prediction error signal and/or the second prediction error signal is adaptively DCT transformed and quantized in adaptive DCT transformer-quantizer 230 at step S330, and then the quantized signal(s) is encoded and outputted in encoder 240 at step S340.

At the other hand, the quantized signal(s) at step S330 is inversely quantized and then adaptively inversely DCT transformed through inverse quantizer-adaptive DCT transformer 250 at step S350.

Subsequently in step S360, prediction signal generator 260 operates based on the outputted signal (i.e. reconstructed prediction error signal) through inverse quantizer-adaptive DCT transformer 250 at step S350 to carry out a motion compensated prediction and others and thereby generates the prediction signals which are then provided to first prediction error signal generator 210 where the first prediction error signal may be generated at step S310.

In addition, reference block generator 270 operates based on the outputted signal (i.e. reconstructed prediction error signal) through inverse quantizer-adaptive DCT transformer 250 at step S350 to generate and provide the reference block required by the second prediction at step S320 to second prediction error signal generator 220, wherein the reference block is not limited to but may be an adjacent block of the current block in one example or a block corresponding in the previous block to the current block.

The adaptive DCT transform at step 330 represents selectively performing the DCT transform or not, based on costs in a frequency domain and in a spatial domain obtained based on a distortion and a rate with respect to first signals generated by performing a DCT transform and a quantization on the first prediction error signals or the second prediction error signals into quantized signals followed by inversely performing a quantization and a DCT transform on the quantized signals and with respect to second signals generated by performing not a DCT transform but a quantization followed by inversely quantizing the first prediction error signals or the second prediction error signals.

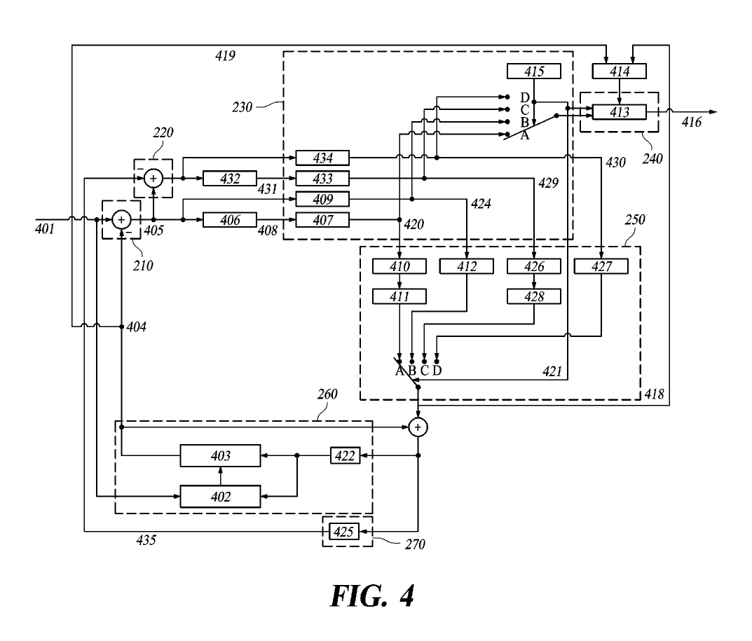

FIG. 4 is a block diagram for illustrating the detail of the video encoding apparatus of FIG. 2 wherein this embodiment is based on the H.264/AVC technology, although it may be implemented in combination with conventional technologies.

In the embodiment of FIG. 4, reference numeral 210 denotes first prediction error signal generator 210 for subtracting the prediction signals outputted from prediction signal generator 260 from an input signal 401 to generate a first prediction error signal 405, and reference numeral 220 denotes second prediction error signal generator 220 for subtracting the prediction error signals 435 of a reference block outputted from reference block generator 270 from an input signal 401 to generate a second prediction error signal.

In the embodiment of FIG. 4, adaptive DCT transformer-quantizer 230 includes a DCT transformer 406 for DCT transforming first prediction error signal 405 to output a prediction error signal 408 in a frequency domain, a quantizer 407 for quantizing the prediction error signal 408 in the frequency domain to output the result as a quantized prediction error signal 420, a quantizer 409 for quantizing the first prediction error signal 405 in a spatial domain to output a quantized prediction error signal 424 in the spatial domain, a DCT transformer 432 for DCT transforming the second prediction error signal outputted from second prediction error signal generator 220 to output a prediction error signal 431 in the frequency domain, a quantizer 433 for quantizing the prediction error signal 431 in the frequency domain to output a quantized prediction error signal 429 in the frequency domain, quantizer 434 for quantizing the second prediction error signal in the spatial domain to output a quantized prediction error signal in the spatial domain, and an adaptive controller 415 for selecting one of the output signals 420, 424, 429, and 430.

In the embodiment of FIG. 4, encoder 240 consists of an entropy encoder 413 and encodes one of the output signals 420, 424, 429, and 430 to output an external output signal 416. In addition, reference numeral 414 represents a scan controller.

Again in the embodiment of FIG. 4, inverse quantizer-adaptive DCT transformer 250 includes an inverse quantizer 410 and inverse DCT transformer 411 for inversely quantizing and inversely DCT transforming the output signal 420, an inverse quantizer 412 for inversely quantizing the output signal 424, an inverse quantizer 426 and inverse DCT transformer 428 for inversely quantizing and inversely DCT transforming the output signal 429, an inverse quantizer 427 for inversely quantizing the output signal 430, and adaptive controller 415 for selecting one of the output signals A, B, C, and D.

Adaptive controller 415 is for determining whether to perform the second prediction based on the prediction errors of the adjacent block or the prediction errors of the motion vector-based previous frame block and thereby switching between the respective frequency domains and the spatial domains, and in an example, controls to obtain costs in the frequency domain and in the spatial domain based on a distortion and a rate with respect to each of the output signals from the construction (411,412,428,427) and consequently select a single route of the lowest corresponding cost out of A, B, C, D to proceed the encoding of the output signals.

In the embodiment of FIG. 4, prediction signal generator 260 may include a memory unit 422 for storing previous images for the estimation of a motion, a motion estimation unit 402 for estimating the motion based on the input signal 401 and the output of memory 422, and a motion compensation prediction unit 403 for generating a prediction signal 404 with a motion compensated prediction based on an output of motion estimation unit 402 and an output of memory unit 422.

Again in the embodiment of FIG. 4, reference block generator 270 includes a memory unit 425 for storing prediction error signals with respect to blocks located in a previous frame and corresponding to adjacent blocks of the current block and/or the current block, and generates a prediction error signal 435 of the reference block and provide it to second prediction error signal generator 220.

A description of the embodiment of FIG. 4 follows.

Input signal 401 undergoes a motion compensated prediction in motion compensation predictor 403 based on motion estimator 402 to provide the prediction signal 404, and first prediction error signal generator 210 subtracts the prediction signal 404 from the input signal 401. The output signal 420 of quantizer 407 is delivered to entropy encoder 413 of encoder 240. Through inverse quantizer 410 and inverse DCT transformer 411, the error signal 420 is used in motion compensation prediction unit 403 for the subsequent prediction step. The prediction error signal after the quantization-inverse transform and inverse DCT transform is delivered to memory unit 425 that stores the image prediction error of the previous frame for the purpose of a second prediction based on the adjacent block of the block to be currently encoded or a motion vector. In addition, the prediction error signal is added to the prediction signal and then delivered to frame memory unit 422 for storing the previous images for motion compensation prediction unit 403 and motion estimation unit 402. An adaptive control is made for switching between the frequency domain and the spatial domain in which the prediction error signal 405.

In this embodiment, from the prediction error signal 405, second prediction error signal generator 220 subtracts the prediction error of a spatial image, the adjacent block prediction error signal 435 as the reference block, or an average value of a left side block and a right side block of the block to be currently encoded to generate a second prediction error signal. The adjacent block prediction error signal 435 takes a prediction error of the corresponding block image from memory unit 425 of reference block generator 270. In some cases, it may use a prediction error of a motion vector-based previous frame block, and in temporal aspect, it may use the prediction error of the corresponding block in the previous frame that is closest to the motion vector-based current block for making the second prediction. The signal from subtracting the adjacent block prediction error or the prediction error 435 of the motion vector-based previous frame block from the prediction error signal 405 is quantized in the frequency domain and the spatial domain. Adaptive controller 415 generates signals and parameters for the purpose of making controls of an adaptive switching between the frequency domain and the spatial domain. Therefore, adaptive control information signals 421 correspond to four switching locations A, B, C, and D. In an inactive state of the second prediction of the present embodiment, when a transform is made in the frequency domain, the switch is placed at A. When the spatial domain is used, the switch goes to location B. On the other hand, in the second prediction performed through the adjacent block prediction error and the prediction error of the motion vector-based previous frame block, when the transform is made in the frequency domain, the switch goes to location C, and use of the spatial domain turns the switch to location D. Entropy encoder 413 also receives a delivery of a side information signal 121 that is the side information signal 421 of the domains, which was used for the encoding procedure of a picture.

The video encoding method through the reference image-based second prediction according to the embodiment of the present disclosure described with reference to FIG. 3 may be implemented by computer-readable recording medium containing program instructions for executing a variety of computer implemented operations. The computer readable recording medium may include program instructions, local data files, local data structures and the like individually or in combination. The recording medium may be designed and configured specifically for the embodiments of the present disclosure or known and available to those skilled in the art of computer software. Examples of the computer-readable recording medium include magnetic media such as hard disks, floppy disks and magnetic tape, optical recording media such as CD-ROM and DVD, magnetic-optical media like floptical disks, and hardware devices like ROM, RAM, flash memory, etc, which are specially constructed to store and execute the program instructions. The recording medium may be transmission medium such as light including a carrier wave or metal wire, waveguide and the like which transmits the program instructions, and signals for designating local data structures and the like. Examples of the program instructions may include high-level language codes that can be executed by a computer using an interpreter and others as well as machine codes composed by the compiler.

In the description above, although all of the components of the embodiments of the present disclosure may have been explained as assembled or operatively connected as a unit, the present disclosure is not intended to limit itself to such embodiments. Rather, within the objective scope of the present disclosure, the respective components may be selectively and operatively combined in any numbers. Every one of the components may be also implemented by itself in hardware while the respective ones can be combined in part or as a whole selectively and implemented in a computer program having program modules for executing functions of the hardware equivalents. Codes or code segments to constitute such a program may be easily deduced by a person skilled in the art. The computer program may be stored in the computer readable media, which in operation can realize the embodiments of the present disclosure. Examples of the computer readable media are magnetic recording media, optical recording media, and carrier wave media and more.

In addition, terms like ‘include’, ‘comprise’, and ‘have’ should be interpreted in default as inclusive or open rather than exclusive or closed unless expressly defined to the contrary. All the terms that are technical, scientific or otherwise agree with the meanings as understood by a person skilled in the art unless defined to the contrary. Common terms as found in dictionaries should be interpreted in the context of the related technical writings not too ideally or impractically unless the present disclosure expressly defines them so.

Although exemplary aspects of the present disclosure have been described for illustrative purposes, those skilled in the art will appreciate that various modifications, additions and substitutions are possible, without departing from essential characteristics of the disclosure. Therefore, exemplary aspects of the present disclosure have not been described for limiting purposes. Accordingly, the scope of the disclosure is not to be limited by the above aspects but by the claims and the equivalents thereof.

### INDUSTRIAL APPLICABILITY

As described above, the present disclosure is highly useful for application in the field of video data compression technology to perform a reference image-based second prediction and an adaptive DCT transform (that is, adaptive quantization in the spatial domain or frequency domain) and reduce the predictive errors remarkably.

### CROSS-REFERENCE TO RELATED APPLICATION

If applicable, this application claims priority under 35 U.S.C. §119(a) on Patent Application No. 10-2009-0083174 filed in Korea on Sep. 3, 2009, the entire content of which is hereby incorporated by reference. In addition, this non-provisional application claims priority in countries, other than the U.S., with the same reason based on the Korean Patent Application, the is entire content of which is hereby incorporated by reference.

1. A method for encoding a video through a reference image-based second prediction, the method comprising:
generating first prediction error signals based on input signals and prediction signals;
generating second prediction error signals based on a first prediction error signal of a current block and a first prediction error signal of a reference block;
performing an adaptive DCT transform followed by a quantization on the first prediction error signals or the second prediction error signals into quantized signals; and
encoding the quantized signals.

2. The method of claim 1, wherein the reference block is an adjacent block of the current block.

3. The method of claim 2, wherein the reference block is a block included in a previous frame and corresponding to the current block.

4. The method of claim 2, wherein the reference block and the prediction signals are based on signals generated from performing an inverse quantization and an adaptive inverse DCT transform on the quantized signals.

5. The method of claim 1, wherein the adaptive DCT transform selectively performs the DCT transform or not based on costs in a frequency domain and in a spatial domain obtained based on a distortion and a rate with respect to first signals generated by performing a DCT transform and a quantization on the first prediction error signals or the second prediction error signals into quantized signals followed by inversely performing a quantization and a DCT transform on the quantized signals and with respect to second signals generated by performing not a DCT transform but a quantization followed by inversely quantizing the first prediction error signals or the second prediction error signals.

6. An apparatus for encoding a video through a reference image-based second prediction, the apparatus comprising:
a first prediction signal generator for generating first prediction error signals based on input signals and prediction signals;
a second prediction signal generator for generating second prediction error signals based on a first prediction error signal of a current block and a first prediction error signal of a reference block;
an adaptive DCT transformer-quantizer for performing an adaptive DCT transform followed by a quantization on the first prediction error signals or the second prediction error signals into quantized signals; and
an encoder for encoding quantized signals.

7. The apparatus of claim 6, further comprising:
an inverse quantizer-adaptive DCT transformer for inversely performing a quantization and an adaptive DCT transform on an output signal of the adaptive DCT transformer-quantizer;
a prediction signal generator for generating the prediction signals based on an output signal of the inverse quantizer-adaptive DCT transformer; and
a reference block generator for generating the reference block based on the output signal of the inverse quantizer-adaptive DCT transformer.

8. The apparatus of claim 7, wherein the reference block is an adjacent block of the current block.

9. The apparatus of claim 7, wherein the reference block is a block included in a previous frame and corresponding to the current block.

10. The apparatus of claim 7, wherein the adaptive DCT transformer-quantizer and the inverse quantizer-adaptive DCT transformer selectively perform a DCT transform and an inverse DCT transform respectively or not based on costs in a frequency domain and in a spatial domain obtained based on a distortion and a rate with respect to first signals generated by performing a DCT transform and a quantization on the first prediction error signals or the second prediction error signals into quantized signals followed by inversely performing a quantization and a DCT transform on the quantized signals and with respect to second signals generated by performing not a DCT transform but a quantization followed by inversely quantizing the first prediction error signals or the second prediction error signals.

11. A computer readable recording medium for recording a program for encoding a video through a reference image-based second prediction, the computer readable recording medium comprising functions of:
generating first prediction error signals based on input signals and prediction signals;
generating second prediction error signals based on a first prediction error signal of a current block and a first prediction error signal of a reference block;
performing an adaptive DCT transform followed by a quantization on the first prediction error signals or the second prediction error signals into quantized signals; and
encoding quantized signals.

12. The computer readable recording medium of claim 11, wherein the reference block is an adjacent block of the current block.

13. The computer readable recording medium of claim 11, wherein the reference block is a block included in a previous frame and corresponding to the current block.

14. The computer readable recording medium of claim 12, wherein the reference block and the prediction signals are based on signals generated from performing an inverse quantization and an adaptive inverse DCT transform on the quantized signals.

15. The computer readable recording medium of claim 11, wherein the adaptive DCT transform selectively performs the DCT transform or not based on costs in a frequency domain and in a spatial domain obtained based on a distortion and a rate with respect to first signals generated by performing a DCT transform and a quantization on the first prediction error signals or the second prediction error signals into quantized signals followed by inversely performing a quantization and a DCT transform on the quantized signals and with respect to second signals generated by performing not a DCT transform but a quantization followed by inversely quantizing the first prediction error signals or the second prediction error signals.

16. The method of claim 3, wherein the reference block and the prediction signals are based on signals generated from performing an inverse quantization and an adaptive inverse DCT transform on the quantized signals.

17. The computer readable recording medium of claim 13, wherein the reference block and the prediction signals are based on signals generated from performing an inverse quantization and an adaptive inverse DCT transform on the quantized signals.
